(19) United States
(12) Patent Application Publication
(10) Pub. No.: US 2014/0224077 A1
(43) Pub. Date: Aug. 14, 2014

(54) LEVER ACTUATED OPEN END RATCHET WRENCH

(71) Applicant: DEMETRIOS ISIDOROS DOUMENIS, JR., Miami, FL (US)

(72) Inventor: DEMETRIOS ISIDOROS DOUMENIS, JR., Miami, FL (US)

(21) Appl. No.: 13/765,870

(22) Filed: Feb. 13, 2013

(51) Int. Cl. B25B 13/46

(52) U.S. Cl. CPC B25B 13/46
USPC 81/58.2

(57) ABSTRACT

Lever actuated open end ratchet wrench that is bi-directional. This wrench is intended to rotate and ratchet over the out points of a nut or bolt in either direction on demand by actuating a lever built into the handle of the wrench. This wrench can be manufactured to fit nuts and bolts with various outer points of contact. This open end ratchet wrench provides the ability to ratchet over the outer points of a nut or bolt in either rotation on demand with smaller rotational degree increments without flipping the wrench over when a lever built into handle is pressed. This wrench can be used as a regular non-ratcheting open end wrench or as an open end ratchet wrench at the discretion of the user.

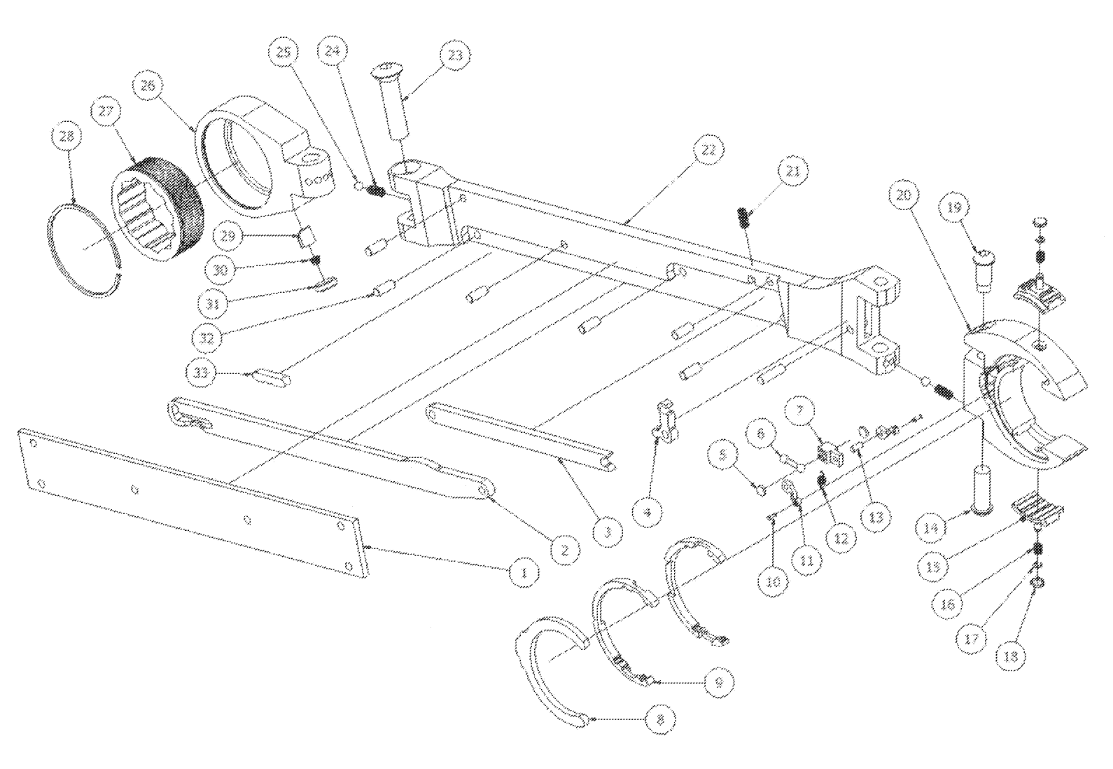

This wrench is a lever actuated open end fine degree ratchet wrench that is bi-directional. The wrench can rotate and ratchet axially over the outer points of a nut or bolt in either directions on demand by actuating the primary lever built into the handle of the wrench. The internal moving components of this wrench are incorporated into the handle and head of the wrench to form the mechanisms that permit the jaws of this wrench to ratchet over the outer points of nut or bolt when the primary lever built into the handle is actuated. Each open end ratchet wrench is manufactured for specific size nuts and bolts. This particular open end ratchet wrench can ratchet over 6 and 12 point nuts or bolts. The distal section of the open end on the head of this wrench incorporates two movable jaws that lock and unlock when the primary lever built in and slightly exposed on bottom side of the wrench handle is lightly pressed or squeezed. The wrench can be used as a non-ratcheting open end wrench by not actuating the primary lever or locking this lever. The head and handle of the wrench can be manufactured in various configurations to facilitate access to nuts and bolts to accommodate desired end user preferences. The head of this wrench can be made to pivot in varying degree from side to side. This wrench can also be made so it is always straight or has a side bend between the head and handle. This wrench uses a double ended ball joint to connect the clevis and final actuation lever to control the internal components between the head and handle section. This wrench can be screwed, riveted, doweled and or welded together with all components assembled inside to form a wrench similar in size, strength and appearance to a standard steel non-ratcheting open end wrench. The distal end of the wrench handle can be manufactured in various configurations to accommodate end user desired preferences. This wrench can be manufactured as a single open end ratchet wrench with a plain handle end with nothing on the end. This wrench can be manufactured so the distal end of the handle is longer to accept a swivel box ratchet wrench and pivot screw. This wrench can also be manufactured so the distal end of the wrench handle has a ridged box ratchet wrench that is straight or bent. The bottom side of this wrench handle incorporates the primary lever built into the handle. Actuating or squeezing this lever and handle releases the jaws inner locking mechanisms to allow the jaws to ratchet freely over the nut or bolt when the wrench is rotated axially over the nut or bolt. Releasing the lever locks the jaws. The internal components of this open end ratchet wrench function and operate the same regardless of desired configurations and accommodations that the end user of this wrench prefers. The primary lever can be manufactured in different configurations to accommodate the end users preference. This wrench can be manufactured in standard, metric and specific size individual wrenches and wrench sets. The user can choose to either loosen or tighten the nut or bolt on demand by actuating the primary lever. Since this open end ratchet wrench is bi-directional, it is not necessary to flip the wrench over to loosen or tighten the nut or bolt unless a better angle is desired provided by the 15 degree radial tilt of the head on the wrench. The proximal tips of this wrench combined with the locked jaws of the wrench can be used as a regular non-ratcheting wrench by not actuating the primary lever or locking the primary lever. This wrench can be manufactured to ratchet in different degrees and accommodate nuts and bolts with various outer points of contact. This particular wrench ratchets every 15 degrees and can accommodate 6 and 12 point nuts and bolts. The 15 degree ratcheting increments is optimal in terms of fine ratcheting increment however the jaws can be manufactured to ratchet in larger or smaller increments. Although this wrench can accommodate 6 and 12 point nuts and bolts, this wrench is more useful on 6 point nuts and bolts due to its design application. The wrench works equally as well to loosen or tighten 12 point nuts and bolts except, the wrench cannot slide on or off the nut or bolt sideways due to the interference between the nut or bolt and the of proximal tips of the wrench. The wrench must be place on and lifted off from the top of the 12 point nut or bolt for access. The wrench will come off a 6 point nut or bolt sideways when the wrench opening is parallel and in-line with the sides of the hex nut or bolt. The primary lever must be actuated to release the jaws in order to align the tips of the wrench opening parallel enough to the sides of the hex nut or bolt to slide the wrench off the fastener sideways.

### BACKGROUND OF THE INVENTION

On Oct. 10, 2010 while replacing a broken motor mount on my car, I could not remove the hex nuts easily due to space constraints. A box or socket wrench couldn't be used. Only a standard open end wrench could access the hex nuts and fit into this space to turn the hex nuts. When using a standard wrench, it had to be flipped over in order to gain more degrees of movement. Using available open end ratchet wrenches was not useful because they ratcheted every 60 degrees and these wrenches are unidirectional. They do not work if the wrench is flipped. Flipping these wrenches tightened the hex nut instead of loosen it. Having been in this same situation several times before, I became intrigued by this dilemma and wanted to create a better open end ratchet wrench that ratcheted over a 6 or 12 point nut or bolt in either rotation with smaller degree increments when a lever is pressed. I envisioned a basic standard and metric set of open end ratchet/box ratchet combination wrenches that are close to the same size and fit as standard and metric non-ratcheting open end/box combination wrenches.

### BRIEF SUMMARY OF THE INVENTION

This is an open end ratchet wrench that is more versatile and useful than available open end ratchet wrenches. This is a lever actuated open end ratchet wrench that is bi-directional. The wrench can rotate and ratchet over 6 or 12 point nuts and bolts in either directions on demand by actuating a lever built into the handle of the wrench. This wrench can be manufactured to fit nuts and bolts with various outer points of contact. This open end ratchet wrench provides the ability to ratchet over the points of a nut or bolt in either rotation on demand with smaller degree increments without flipping the wrench over when a lever built into the handle is pressed. This wrench can be used as a regular non-ratcheting open end wrench or as an open end ratchet wrench at the discretion of the user.

### DETAILED DESCRIPTION OF THE INVENTION

Lever actuated open end ratchet wrench incorporating a double ended ball joint 6 connected to a clevis 7 located in a hole on the back side of the wrench head 20 to connect the third lever 4 in the wrench handle 22. The opposite end of the clevis 7 connects two identical cam connecting rods 11 that oppose each other and are connected to two identical cams 9 that face each other and rotate in opposite directions of each other in the head 20 of the wrench when the primary lever 2 is actuated. The proximal end of the wrench handle 22 has holes through the top and bottom sides to accept the top socket cap screw 19 and bottom socket cap screw 14 to connect the wrench head 20 and allow it to pivot. The detents on the proximal bottom section of the wrench handle 22 and the ball 25 and compression spring 24 in the wrench head 20 maintain the swivel position between the wrench head 20 and the wrench handle 22. The distal end of the wrench handle 22 has holes through the top and bottom sides to accept a flat head socket cap screw 23 and pivoting ratchet box wrench body 26. The detents on the box wrench body 26 and the ball 25 and compression spring 24 in the handle 22, maintain the swivel position between the box wrench body 26 and the handle 22. The box wrench 27 is retained in the box wrench body 26 with the large C-clip 28. The box wrench ratchet 29 and compression spring 30 are retained against the box wrench 27 with the set screw 31. All wrench body components of this wrench are precision made from hardened tool steel and chrome plated. The wrench is riveted and/or doweled together with all components assembled inside to form the open end ratchet wrench. This wrench is similar in size and appearance to a standard harden steel box ratchet/non-ratcheting open end wrench except for the small exposed section of the primary lever 2 on the handle 22 and ratcheting jaws 15 on the distal section of the open end wrench. The inner components of this wrench are precision made from hardened tool steel and plated with a durable dry Teflon® lubricating nickel plating material to provide smooth maintenance free lubrication and to prevent galling between metal components. The handle 22 of this wrench is tilted 15 degrees from the head 20 to facilitate access to outer points of the fasteners. The ratcheting jaws 15 fit into the wrench head 20 and distal section of open end wrench. This section of the wrench has a relief pocket to allow clearance for the outer points of the fastener to rotate freely in the wrench and allow the jaws 15 to move up and down when the primary lever 2 is actuated. Unlocking the jaws 15 allows the wrench to rotate axially over the outer points of fasteners. The jaws 15 have bumps on the top side that fit into the grooves on the two identical cams 9 when the primary lever 2 is actuated. Actuating the primary lever 2 ultimately rotates the two identical cams 9 in opposite directions of each other aligning the grooves on the cams 9 with the bumps on the jaws 15. Actuating the primary lever 2 aligns the grooves on the cams 9 with the bumps on the jaws 15 and unlocks the jaws 15 by provides space for the bumps on the jaws 15 to engage in and out of the grooves on the cams 9 freely when the wrench is rotated axially over the outer points of a fastener. Releasing the primary lever 2 returns the cams 9 to their original position and locks the jaws 15 by blocking the bumps on the jaws 15 with the inner diameter of the cams 9. The stem on top of the jaws 15 retains the jaw compression springs 16. The jaw compression springs 16 maintain a light consistent force on the jaws 15 to allow them to ratchet over the outer points of a fastener easily and return to the jaws 15 to their original position. The stem on top of the jaw guides the jaws 15 in the two smaller bores on the top and bottom side of the wrench head 20 to ensure they move up and down straight and evenly. The two small C-clips 17 retain the jaws 15 in the wrench head 20. The small C-clips 17 and the depth of the larger bores on the top and bottom side on the head 20 of the wrench limits the movement of the jaws 15. This prevents the jaws 15 from traveling into and past the wrench opening and aligns the jaw 15 tips parallel and inline to the proximal tips on the wrench head 20. The two dust caps 18 fit into the larger bores on the top and bottom of the wrench head 20 to protect the jaw 15 stems. The cam cover 8 retains the two cams 9. The cams 9 have two relief slots on the top and bottom side to allow the stem of the jaws 15 and jaw compression springs 16 to move freely through the cams 9 as the jaws 15 ratchet over the outer points of the fastener. The ratcheting increments of the wrench are dictated by number of teeth on the jaws 15. The jaws 15 movement over the outer points of the fastener is dictated by the radiuses of the peaks on the teeth of the jaws 15. The movable jaws 15 are locked in the closed position until the primary lever 2 built into the handle of the wrench bodies is slightly actuated. Actuating the primary lever 2 does not move the jaws 15. Actuating the primary lever 2 unlocks the jaws 15. Slightly pushing or squeezing the primary lever 2 by hand moves the secondary lever 3 built into the handle of the wrench bodies up and down. The small holes in the primary 2 and secondary lever 3 allow these levers to pivot on the dowels pins 32 that retain them in the handle 22 of the wrench bodies. The location of the two holes for the dowel pins 32 in the wrench handle 22 for the primary 2 and secondary levers 3 cross the pivot bump on the primary lever 2 and reverses the angle movement of the secondary lever 3. The fork on the secondary lever 3 captures the small arm on the third lever 4 that pivots on a dowel pin 32 in the handle of the wrench. The fork on the secondary lever 3 moves the arm on the third lever 4 up and down when the primary lever 2 is actuated. When the small arm of the third lever 4 moves up, the fork on top of the third lever 4 moves towards the head 20 pushing the double ended ball joint 6 and clevis 7. When small arm of the third lever 4 moves down, the fork on top of the third lever 4 moves away from the head 20 of the wrench pulling the double ended ball joint 6 and clevis 7 back to its original position. The top of the third lever 4 captures one of the balls of the double ended ball joint 6 and the clevis 7 captures the other ball. The two clevis side caps 5 keep the other ball of the double ended ball joint 6 in the center of the clevis 7. The third lever 4 connected by the double ended ball joint 6 pushes and pulls the back side of the clevis 7 in the hole on the back side of the wrench head 20. The clevis dowel pin 13 pressed through the front side hole of the clevis 7 is connected to the holes on the butt of the two identical cam connecting rods 11. One side of the butt on the two cam connecting rods 11 is located on each side of the hole on the front of the clevis 7. The butt of the two cam connecting rods 11 move linearly forward and backwards with the clevis 7 and pivot on the clevis dowel pin 13 freely while pushing and pulling the two identical cams 9. The knuckle of the two cam connecting rods 11 located on the end opposite of the butt is captured in the groove on each cam 9. The knuckle on cam connecting rod 11 rotates the cams 9 axially in opposite directions of each other and pivots in groove provided on the two cams 9 as the clevis 7 pushes and pulls the cam connecting rods 11 forwards and backwards. The two cams 9 rotate axially in opposite directions of each other from the locked position to the unlocked position when the knuckles on the two cam connecting rods 11 push the groove on the cams 9. The extension spring 12 connected to the spring post 10 on both knuckles of the cam connecting rods 11 pulls and returns the cam connecting rods 11 and the cams 9 back to the original locked position when the primary lever 2 is released. The lever compression spring 21 located above the secondary lever 3 inside the handle 22 pushes the three actuating levers and pulls the clevis7 backwards when the primary lever 2 is released. The primary lever 2 can be locked by moving the primary lever lock 33 backwards to block the dowel pin 32 that retains the distal section of the primary lever 2. The handle cover 1 retains the primary lever 2, secondary lever 3 and lever compression spring 21.

### BREIF DESCRIPTION OF THE DRAWING

This is a drawing showing an exploded view of all parts to the invention.

1. This lever actuated open end ratchet wrench is bi-directional and can rotate and ratchet over the outer points of nuts and bolts in either direction on demand by actuating a lever built into the handle of the wrench.

2. This lever actuated open end ratchet wrench provides the ability to ratchet over the outer points of nuts and bolts in either rotation on demand with smaller rotational degree increments without flipping the wrench over when the lever built into handle is actuated.

3. This lever actuated open end ratchet wrench can be used as a non-ratcheting open end wrench or as an open end ratchet wrench at the discretion of the user.
